(19) United States
(12) Patent Application Publication
(10) Pub. No.: US 2020/0311750 A1
(43) Pub. Date: Oct. 1, 2020

(54) Demand Sensing for Product and Design Introductions

(71) Applicant: International Business Machines Corporation, Armonk, NY (US)

(72) Inventors: Akshay Gugnani, Bangalore (IN); Vikas C. Raykar, Bangalore (IN); Amith Singhee, Bangalore (IN); Vijay Ekambaram, Bangalore (IN); Surya Shravan Kumar Sajja, Bangalore (IN)

(21) Appl. No.: 16/369,100

(22) Filed: Mar. 29, 2019

(51) Int. Cl. G06Q 30/02; G06N 3/08; G06F 16/583

(52) U.S. Cl. CPC G06Q 30/0202; G06N 3/08; G06F 16/5838; G06F 16/5854; G06Q 30/0201

(57) ABSTRACT

Methods, systems, and computer program products for demand sensing for product and design introductions are provided herein. A computer-implemented method includes receiving a query comprising information pertaining to an enterprise offering; determining a given number of similar past enterprise offerings based on a comparison of the enterprise offering against a collection of past enterprise offerings and user reviews of the past enterprise offerings; extracting multiple features from the given number of similar past enterprise offerings; generating, for each of the extracted features, a feature-based demand score based on analysis of the user reviews of the given number of similar past enterprise offerings; determining demand for the enterprise offering by aggregating the feature-based demand scores with similarity scores attributed to the enterprise offering with respect to the given number of similar past enterprise offerings; and outputting the demand for the enterprise offering to an enterprise user.

### FIELD

The present application generally relates to information technology and, more particularly, to commercial management techniques.

### BACKGROUND

Companies commonly struggle with demand variability and meeting consumer demand with an appropriate supply at an appropriate location at an appropriate time. Such challenges are particularly prevalent in connection with new products and/or designs. New products and/or designs generally do not have user feedback, and as such, accurately predicting demand for such products and/or designs is often difficult.

### SUMMARY

In one embodiment of the present invention, techniques for demand sensing for product and design introductions are provided. An exemplary computer-implemented method includes receiving a query comprising information pertaining to an enterprise offering, and determining a given number of similar past enterprise offerings based at least in part on a comparison of the enterprise offering against a collection of past enterprise offerings and user reviews of the past enterprise offerings. Such a method also includes extracting multiple features from the given number of similar past enterprise offerings via implementation of one or more feature-based prioritization techniques, wherein the multiple extracted features are prioritized over other features from the given number of similar past enterprise offerings based at least in part on similarity to one or more features of the enterprise offering. Additionally, such a method includes generating, for each of the multiple extracted features, a feature-based demand score based at least in part on analysis of the user reviews of the given number of similar past enterprise offerings. Further, such a method additionally includes determining demand for the enterprise offering by aggregating the feature-based demand scores with similarity scores attributed to the enterprise offering with respect to the given number of similar past enterprise offerings, and outputting the demand for the enterprise offering to at least one enterprise user.

In another embodiment of the present invention, a computer-implemented method includes generating a database containing data attributed to past enterprise offerings, wherein the data comprise image data, text-based description data, and categorical data. Such a method also includes determining, with respect to a given enterprise offering, a given number of similar past enterprise offerings based at least in part on a comparison of the given enterprise offering against (i) the data contained in the database and (ii) user reviews of the past enterprise offerings. Additionally, such a method includes extracting multiple prioritized features from the given number of similar past enterprise offerings via implementing one or more visual similarity models using deep learning, applying weights to the multiple extracted prioritized features based at least in part on similarity to one or more features of the given enterprise offering, and generating, for each of the multiple extracted prioritized features, a feature-based demand score based at least in part on analysis of the user reviews of the given number of similar past enterprise offerings. Further, such a method includes determining demand for the given enterprise offering by aggregating the feature-based demand scores with similarity scores attributed to the given enterprise offering with respect to the given number of similar past enterprise offerings, and outputting the demand for the given enterprise offering to at least one enterprise user.

Yet another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating a direct method approach, according to an exemplary embodiment of the invention;

FIG. 3 is a diagram illustrating an aspect-based prioritization method approach, according to an exemplary embodiment of the invention;

FIG. 4 is a flow diagram illustrating techniques according to an embodiment of the invention;

FIG. 5 is a system diagram of an exemplary computer system on which at least one embodiment of the invention can be implemented;

FIG. 6 depicts a cloud computing environment according to an embodiment of the present invention; and

FIG. 7 depicts abstraction model layers according to an embodiment of the present invention.

### DETAILED DESCRIPTION

As described herein, an embodiment of the present invention includes demand sensing for product and design introductions. At least one embodiment includes predicting demand of new enterprise offerings (for example, product introductions and/or design queries) based at least in part on explainable aspect/feature correlation provided by aggregating demand of similar enterprise offering data processed from the top-k neighboring previous enterprise offerings. As used herein, “demand” refers to a signal which can include sentiment, sales, sell-through rate, etc. Such an embodiment includes extracting and/or generating enterprise offering data vectors for a new enterprise offering as well as previous/existing enterprise offerings, and computing a similarity measure between the new enterprise offering and one or more of the previous/existing enterprise offerings. Additionally, all enterprise offering data vectors can be stored in a database and/or store.

As further detailed herein, at least one embodiment additionally includes predicting demand for a new enterprise offering by fetching the top-k neighboring enterprise offerings from a database (such as noted above, storing enterprise offering data vectors) based on one or more similarities, and aggregating demand values associated with the fetched enterprise offerings (determined in connection with user reviews of the previously/existing enterprise offerings) based on explainable aspects dominating and/or prevalent among the offering similarities. In such an embodiment, demand vectors are computed using a regression model trained on a corpus of offering data and demand data, and such demand vectors are subsequently utilized for predicting a demand vector for any given combination of enterprise offering vectors.

At least one embodiment includes determining that one or more features and/or aspects of an enterprise offering comparison dominate a similarity module using explainable artificial intelligence (AI) modules (such as, for example, visual similarity models using deep learning, etc.), and using these features/aspects as anchor for selectively discovering demand and/or sentiments pertaining to these features/aspects. Accordingly, such an embodiment includes generating a demand forecast that precludes the need for mapping potentially irrelevant demand signals across approximately similar offerings. Additionally, such an embodiment includes grounding new enterprise offering introductions based on location feature similarity to predict demand in new and/or different locations.

As detailed herein, one or more embodiments include building and indexing enterprise offering data, user/customer data, and location data within a database and/or data store. Such an embodiment includes extracting offering data vectors for various enterprise offerings from image data, description data, category data, etc. Such vectors can be expressed, for example, in multiple modalities, such as embedding space, attributes, color space, flavor space, etc. Accordingly, such vectors can be used, as further described herein, to compute a similarity measure between any two offerings. Further, such vectors can be stored in one or more databases and/or data stores.

Such an embodiment additionally includes extracting aspect- and/or feature-based demand measures from text data (reviews, user comments, etc.) and ratings for each enterprise offering, expressed by an individual (person or other entity) at a given location. Such extractions can include extracting individual user vectors (including user age data, user gender data, etc.) and location vectors (including coordinates, demographics, climate, etc.). Additionally, the above-noted demand measures can be stored as demand vectors keyed to an offering vector, an individual user vector, and/or a location vector. As used herein, “keyed to” refers to a concept similar to indexing, wherein given a location or user identifier (ID), the system can obtain the corresponding aggregated demand.

As also detailed herein, one or more embodiments includes demand sensing for new enterprise offerings (e.g., new products, new designs, etc.) based at least in part on explainable aspect correlation. Given a new enterprise offering to be introduced in the market, such an embodiment includes predicting the offering's demand by fetching the top-k neighboring and/or similar offerings from a database based on offering data similarity, and aggregating the demand attributed to at least a portion of the features/aspects of those similar offerings. By way merely of example, in the fashion domain, given a product image, an embodiment of the invention can include extracting the top-k similar products using image and/or text-based searching. Such an embodiment additionally includes identifying one or more features and/or aspects of the top-k similar products that are most prevalent/dominant in connection with the searching. By way of example, prevalent/dominant features can be identified based on visual similarity. For instance, upon a determination from an AI module that two images are similar, at least one embodiment additionally includes extracting which feature(s) is/are common across the images using an explainable visual search, and those common aspects are deemed the dominating aspects/features. Also, in one or more embodiments, pattern-related sentiments (wherein a pattern is also an aspect/feature) derived from these top-k similar offerings are aggregated to generate an estimate of the demand for the new offering.

As also detailed herein, at least one embodiment includes grounding new enterprise offerings with respect to location data and/or user/consumer data, and building one or more regressing models to predict demand sensing for new enterprise offerings for new locations and/or new user/consumer profiles. In such an embodiment, computation of a demand vector includes using the one or more regression models to estimate the demand vector given a query containing new enterprise offering information as input to the model(s). The one or more regression models are trained on a corpus of offering data and demand data to predict the demand vector for any given combination of offering data, user/consumer data, and location data.

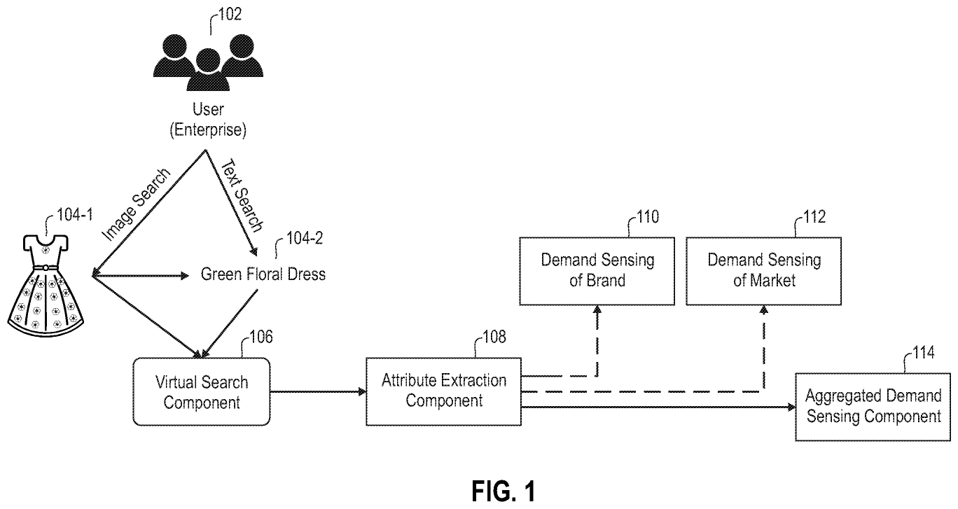

FIG. 1 is a diagram illustrating system architecture, according to an embodiment of the invention. By way of illustration, FIG. 1 depicts a user (e.g., an enterprise user) 102, who provides input in the form of a query (an image-based query and/or a text-based query) and optionally brand and/or market information. In the example depicted in FIG. 1, the input query involves a green floral dress, and as illustrated via steps 104-1 and 104-2, an image search and a text search, respectively, are carried out. The results of those searches are output to a visual search component 106, which analyzes the results and generates an image list of similar enterprise offerings (having reviews and/or user feedback) related to the particular brand and market information in question. The visual search component 106 then outputs the generated image list to an attribute extraction component 108, which extracts one or more aspects and/or features highly prevalent and/or dominating the visual search component output.

The attribute extraction component 108 utilizes various groups of semantic attributes (which can, for example, cover a spectrum of offering categories, features and aspects in the relevant brand and/or market) to tag images with the attributes and train a set of classifiers for individual visual attributes. Additionally, using explainable AI, the attribute extraction component 108 filters for highly prevalent and/or dominating attributes (e.g., color, pattern, style, occasion, etc.) in the visual search results. Once such attributes are identified, they are used to search other (previous/existing) offerings with similar attributes.

Also, in one or more embodiments, the attribute extraction component 108 outputs the identified attributes to an aggregated demand sensing component 114, which, for each of the identified attributes, derives attribute-based demand scores from reviews of the similar enterprise offerings, both with respect to brand information 110 and market information 112. The aggregated demand sensing component 114 then aggregates the attribute-based demand scores (for example, by combining attribute-based demand scores and vision similarity scores) to estimate and/or predict the demand of the enterprise offering of interest. Accordingly, in one or more embodiments, demand pertaining to attributes such as, for example, price, logistics, delivery, etc., which cannot generally be mapped across visually similar products are eliminated, leading to improved accuracy.

The output (via the aggregated demand sensing component 114) of such a system includes a demand sensing for the enterprise offering in question (e.g., a mapping of overall demand from the enterprise offering in question to one or more visually similar offerings).

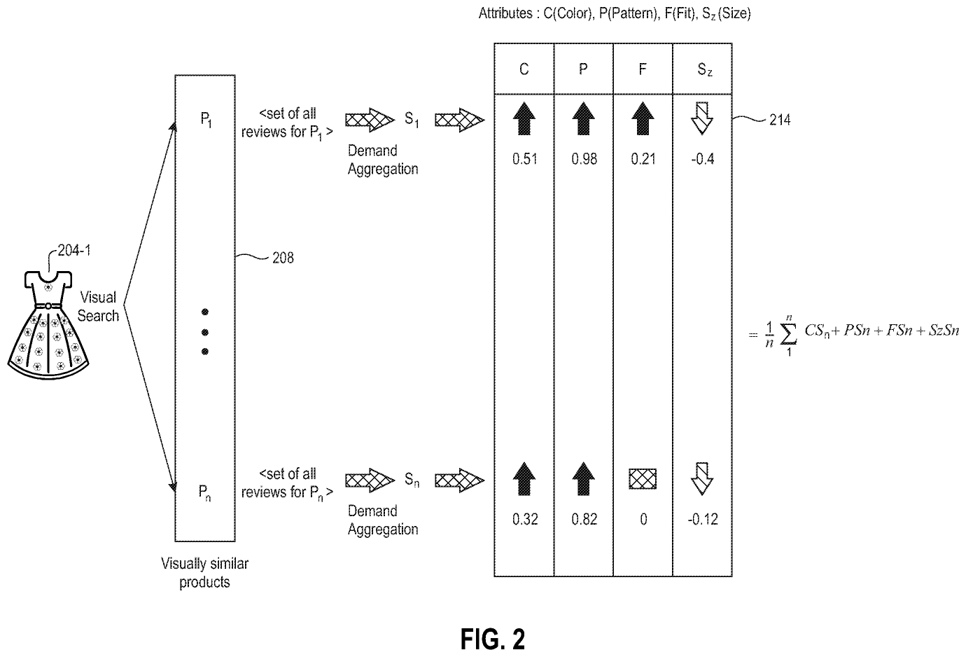

FIG. 2 is a diagram illustrating a direct method approach, according to an exemplary embodiment of the invention. By way of illustration, FIG. 2 depicts the output of a visual search 204-1 being provided to an attribute extraction component 208, which identifies attributes of color (C), pattern (P), fit (F), and size (S_{z}) in the provided output. An aggregated demand sensing component 214, for each of the identified attributes, derives attribute-based demand scores (S₁ through Sₙ) from reviews of the list of similar enterprise offerings (P₁ through Pₙ). Based on these scores, the aggregated demand sensing component 214 then generates an aggregated demand-based score, via the equation 1/nΣ₁ⁿCSn+PSn+FSn+SzSn, to represent an estimated demand for the offering in question.

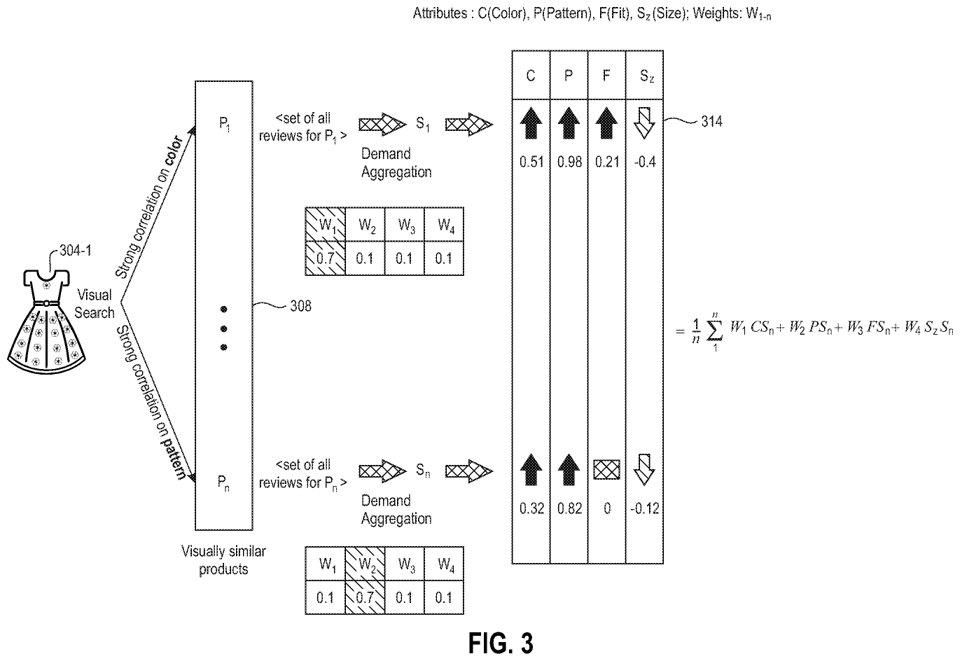

FIG. 3 is a diagram illustrating an aspect-based prioritization method approach, according to an exemplary embodiment of the invention. By way of illustration, FIG. 3 depicts the output of a visual search 304-1 being provided to an attribute extraction component 308, which identifies attributes of color (C), pattern (P), fit (F), and size (S_{z}) in the provided output. An aggregated demand sensing component 314, for each of the identified attributes, derives attribute-based demand scores (S₁ through Sₙ) from reviews of the list of similar enterprise offerings (P₁ through Pₙ), and applies distinct weights (W₁₋ₙ) thereto (based, for example, on the level of correlation of the given attribute indicated by the visual search). Based on these scores, the aggregated demand sensing component 314 then generates an aggregated demand-based score, via the equation 1/nΣ₁ⁿW1CSn+W2PSn+W3FSn+W4SzSn, to represent an estimated demand for the offering in question.

As also detailed herein, one or more embodiments include grounding new enterprise offerings with respect to location and/or user/consumer data vectors and building regression models to predict demand sensing for new enterprise offerings for new and/or different locations and consumer profiles (based on location/consumer data similarity learnt in the regression model). By way of example, for a given product P, reviews from different locations can be used build a model fₚ: X→y, wherein X=location-based training features for the forecasting/predicting demand, and y=market demand as training output.

Additionally, user/consumer data can be incorporated and can include consumer status information (e.g., the consumer can be an online consumer, and/or a consumer for a brick and mortar store, etc.). For a given enterprise offering, data for an online consumer can include features such as age, gender, location, cart composition, purchase history, click view history, etc. Alternately, for a given enterprise offering, data for a brick and mortar consumer can include features such as gender, location, product size, basket composition, purchase history, etc.

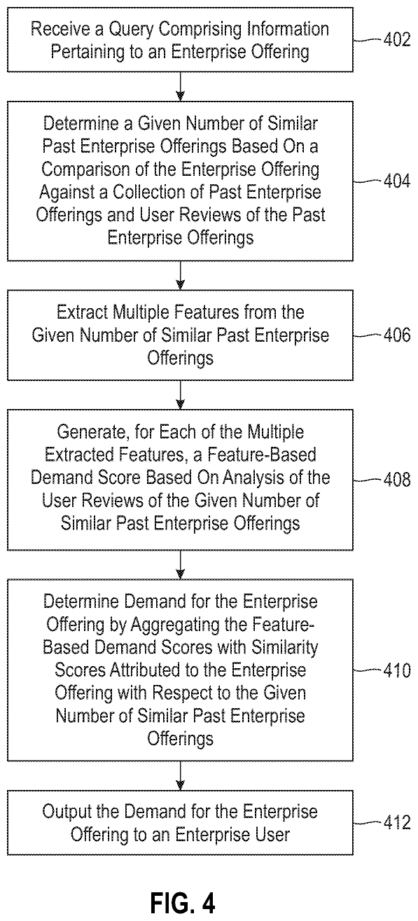

FIG. 4 is a flow diagram illustrating techniques according to an embodiment of the present invention. Step 402 includes receiving a query comprising information pertaining to an enterprise offering. In at least one embodiment, the query includes an image-based query and/or a text-based query.

Step 404 includes determining a given number of similar past enterprise offerings based at least in part on a comparison of the enterprise offering against a collection of (i) past enterprise offerings and (ii) user reviews of the past enterprise offerings. In one or more embodiments, the user reviews include user demographic data and user location data. At least one embodiment additionally includes generating a database containing data attributed to the collection of past enterprise offerings, wherein the data comprise vectors derived from at least one of image data, text-based description data, and categorical data, and wherein the vectors expressed in one or more modalities.

Step 406 includes extracting multiple features from the given number of similar past enterprise offerings via implementation of one or more feature-based prioritization techniques, wherein the multiple extracted features are prioritized over other features from the given number of similar past enterprise offerings based at least in part on similarity to one or more features of the enterprise offering. Implementation of one or more feature-based prioritization techniques can include implementing one or more visual similarity models using deep learning. Additionally, at least one embodiment also includes applying weights to the multiple extracted features.

As detailed herein, feature-based prioritization techniques can result in variable prioritization (that is, feature extraction) across every different groups or pairs of offerings compared for similarity. For example, consider for Offering A and Offering B, Offering A may be similar to Offering B from a coloring aspect, while being dissimilar in other aspects. Accordingly, in such an example, the coloring feature is extracted, and the coloring demand of Offering B can be mapped to Offering A (while other aspects are note extracted and/or are given a low priority).

Step 408 includes generating, for each of the multiple extracted features, a feature-based demand score based at least in part on analysis of the user reviews of the given number of similar past enterprise offerings. In at least one embodiment, generating the feature-based demand score includes computing a demand vector using a regression model trained on a corpus of enterprise offering data and demand data. In such an embodiment, the regression model can include a gradient-boosted ensemble of regression trees.

Step 410 includes determining demand for the enterprise offering by aggregating the feature-based demand scores with similarity scores attributed to the enterprise offering with respect to the given number of similar past enterprise offerings. Determining the demand for the enterprise offering can include determining the demand for the enterprise offering for one or more locations and one or more consumer profiles distinct from locations and consumer profiles corresponding to data pertaining to the collection of past enterprise offerings. Additionally, determining the demand for the enterprise offering for one or more locations and one or more consumer profiles distinct from locations and consumer profiles corresponding to data pertaining to the collection of past enterprise offerings can include implementing one or more regression models in connection with the data pertaining to the collection of past enterprise offerings

Step 412 includes outputting the demand for the enterprise offering to at least one enterprise user. The techniques depicted in FIG. 4 can also include deriving enterprise offering data vectors (i) from each of the past enterprise offerings and (ii) from the enterprise offering. In such an embodiment, determining a given number of similar past enterprise offerings includes comparing the enterprise offering data vector from the enterprise offering to the enterprise offering data vectors from each of the past enterprise offerings. Further, in one or more embodiments, deriving an enterprise offering data vector for a given enterprise offering includes extracting enterprise offering data from the given enterprise offering, wherein the enterprise offering data comprise at least one of image-related data, description-related data, and category-related data. Also, in at least one embodiment, each enterprise offering data vector is expressed in multiple modalities, wherein the multiple modalities can include an embedding space modality, an attribute-based modality, a color space modality, and/or a flavor space modality.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

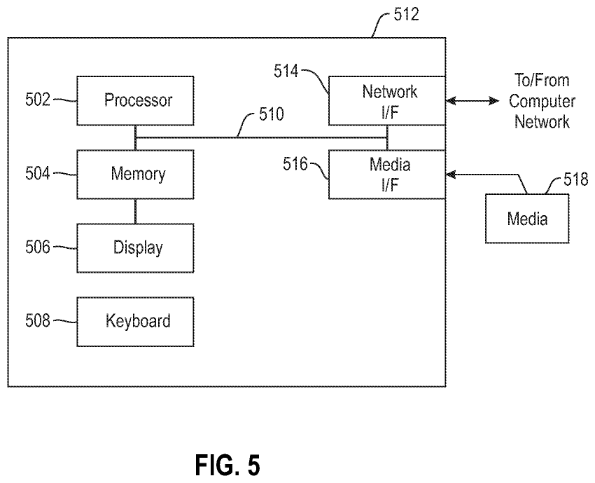

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

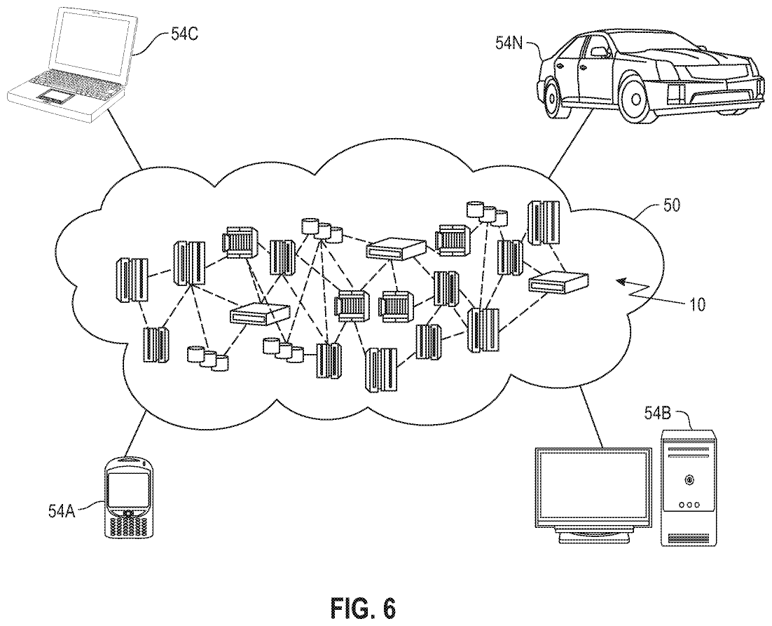

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

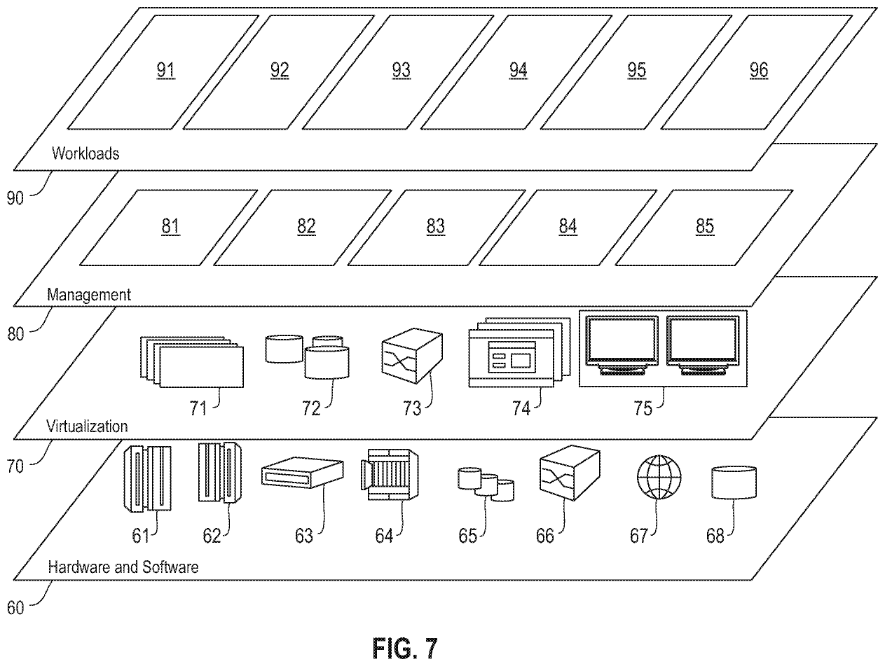

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and demand sensing 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, using explainable aspect correlation provided by aggregating demand of similar products fetched from the top-k neighbor products of a product store for predicting demand of new product introductions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a query comprising information pertaining to an enterprise offering;
determining a given number of similar past enterprise offerings based at least in part on a comparison of the enterprise offering against a collection of (i) past enterprise offerings and (ii) user reviews of the past enterprise offerings;
extracting multiple features from the given number of similar past enterprise offerings via implementation of one or more feature-based prioritization techniques, wherein the multiple extracted features are prioritized over other features from the given number of similar past enterprise offerings based at least in part on similarity to one or more features of the enterprise offering;
generating, for each of the multiple extracted features, a feature-based demand score based at least in part on analysis of the user reviews of the given number of similar past enterprise offerings;
determining demand for the enterprise offering by aggregating the feature-based demand scores with similarity scores attributed to the enterprise offering with respect to the given number of similar past enterprise offerings; and
outputting the demand for the enterprise offering to at least one enterprise user;
wherein the method is carried out by at least one computing device.

2. The computer-implemented method of claim 1, wherein said implementation of one or more feature-based prioritization techniques comprises implementing one or more visual similarity models using deep learning.

3. The computer-implemented method of claim 1, comprising:
generating a database containing data attributed to the collection of past enterprise offerings, wherein the data comprise vectors derived from at least one of image data, text-based description data, and categorical data, and wherein the vectors are expressed in one or more modalities.

4. The computer-implemented method of claim 1, wherein said determining the demand for the enterprise offering comprises determining the demand for the enterprise offering for (i) one or more locations and one or more consumer profiles distinct from (ii) locations and consumer profiles corresponding to data pertaining to the collection of past enterprise offerings.

5. The computer-implemented method of claim 4, wherein said determining demand comprises implementing one or more regression models in connection with the data pertaining to the collection of past enterprise offerings.

6. The computer-implemented method of claim 1, wherein said generating the feature-based demand score comprises computing a demand vector using a regression model trained on a corpus of enterprise offering data and demand data.

7. The computer-implemented method of claim 6, wherein the regression model comprises a gradient-boosted ensemble of regression trees.

8. The computer-implemented method of claim 1, wherein the user reviews comprise user demographic data and user location data.

9. The computer-implemented method of claim 1, comprising:
deriving enterprise offering data vectors (i) from each of the past enterprise offerings and (ii) from the enterprise offering.

10. The computer-implemented method of claim 9, wherein said determining a given number of similar past enterprise offerings comprises comparing the enterprise offering data vector from the enterprise offering to the enterprise offering data vectors from each of the past enterprise offerings.

11. The computer-implemented method of claim 9, wherein said deriving an enterprise offering data vector for a given enterprise offering comprises extracting enterprise offering data from the given enterprise offering, wherein the enterprise offering data comprise at least one of image-related data, description-related data, and category-related data.

12. The computer-implemented method of claim 9, wherein each enterprise offering data vector is expressed in multiple modalities, wherein the multiple modalities comprise two or more of an embedding space modality, an attribute-based modality, a color space modality, and a flavor space modality.

13. The computer-implemented method of claim 1, comprising:
applying weights to the multiple extracted features.

14. The computer-implemented method of claim 1, wherein the query comprises at least one of an image-based query and a text-based query.

15. A computer program product comprising a computer readable storage medium having program instructions embodied therewith, the program instructions executable by a computing device to cause the computing device to:
receive a query comprising information pertaining to an enterprise offering;
determine a given number of similar past enterprise offerings based at least in part on a comparison of the enterprise offering against a collection of (i) past enterprise offerings and (ii) user reviews of the past enterprise offerings;
extract multiple features from the given number of similar past enterprise offerings via implementation of one or more feature-based prioritization techniques, wherein the multiple extracted features are prioritized over other features from the given number of similar past enterprise offerings based at least in part on similarity to one or more features of the enterprise offering;
generate, for each of the multiple extracted features, a feature-based demand score based at least in part on analysis of the user reviews of the given number of similar past enterprise offerings;
determine demand for the enterprise offering by aggregating the feature-based demand scores with similarity scores attributed to the enterprise offering with respect to the given number of similar past enterprise offerings; and
output the demand for the enterprise offering to at least one enterprise user.

16. The computer program product of claim 15, wherein said generating the feature-based demand score comprises computing a demand vector using a regression model trained on a corpus of enterprise offering data and demand data.

17. The computer program product of claim 15, wherein said implementation of one or more feature-based prioritization techniques comprise implementing one or more visual similarity models using deep learning.

18. The computer program product of claim 15, wherein said determining the demand for the enterprise offering comprises determining the demand for the enterprise offering for (i) one or more locations and one or more consumer profiles distinct from (ii) locations and consumer profiles corresponding to data pertaining to the collection of past enterprise offerings.

19. A system comprising:
a memory; and
at least one processor operably coupled to the memory and configured for:
receiving a query comprising information pertaining to an enterprise offering;
determining a given number of similar past enterprise offerings based at least in part on a comparison of the enterprise offering against a collection of (i) past enterprise offerings and (ii) user reviews of the past enterprise offerings;
extracting multiple features from the given number of similar past enterprise offerings via implementation of one or more feature-based prioritization techniques, wherein the multiple extracted features are prioritized over other features from the given number of similar past enterprise offerings based at least in part on similarity to one or more features of the enterprise offering;
generating, for each of the multiple extracted features, a feature-based demand score based at least in part on analysis of the user reviews of the given number of similar past enterprise offerings;
determining demand for the enterprise offering by aggregating the feature-based demand scores with similarity scores attributed to the enterprise offering with respect to the given number of similar past enterprise offerings; and
outputting the demand for the enterprise offering to at least one enterprise user.

20. A computer-implemented method comprising:
generating a database containing data attributed to past enterprise offerings, wherein the data comprise image data, text-based description data, and categorical data;
determining, with respect to a given enterprise offering, a given number of similar past enterprise offerings based at least in part on a comparison of the given enterprise offering against (i) the data contained in the database and (ii) user reviews of the past enterprise offerings;
extracting multiple prioritized features from the given number of similar past enterprise offerings via implementing one or more visual similarity models using deep learning;
applying weights to the multiple extracted prioritized features based at least in part on similarity to one or more features of the given enterprise offering;
generating, for each of the multiple extracted prioritized features, a feature-based demand score based at least in part on analysis of the user reviews of the given number of similar past enterprise offerings;
determining demand for the given enterprise offering by aggregating the feature-based demand scores with similarity scores attributed to the given enterprise offering with respect to the given number of similar past enterprise offerings; and
outputting the demand for the given enterprise offering to at least one enterprise user;
wherein the method is carried out by at least one computing device.
